(19) United States
(12) Patent Application Publication
(10) Pub. No.: US 2026/0251044 A1
(43) Pub. Date: Aug. 27, 2026

(54) METHOD AND SYSTEM FOR ENHANCING SUBSURFACE PERMEABILITY VIA ELECTROMAGNETIC FIELDS AND ELECTROMAGNETICALLY RESPONSIVE PARTICLES

(71) Applicant: Daniel Seth Helman, Los Angeles, CA (US)

(72) Inventor: Daniel Seth Helman, Los Angeles, CA (US)

(73) Assignee: Daniel Seth Helman, Venice, CA (US)

(21) Appl. No.: 19/651,840

(22) Filed: Apr. 20, 2026

(51) Int. Cl. E21B 43/27; C09K 8/05; E21B 43/26; H01F 7/18

(52) U.S. Cl. CPC E21B 43/27; C09K 8/05; E21B 43/2607; H01F 7/1844

(57) ABSTRACT

A method for enhancing mineral dissolution and permeability in subsurface rock formations, and a corresponding system, is provided. Electromagnetically responsive granular particles are introduced into fracture networks or fluid pathways within a subsurface formation. A surface-based generation apparatus applies an electromagnetic field that inductively couples with conductive fluids within the fractures or pathways, inducing localized electric currents at formation depth. Interaction between the induced electric currents and the granular particles modifies local electric field gradients and current distributions, thereby inducing electrochemical redox reactions at adjacent mineral surfaces and enhancing mineral dissolution and permeability. The invention is applicable to hydrocarbon reservoirs, geothermal systems, and mineral extraction applications, and is compatible with hydraulic fracturing, hydraulic shearing, and well completion workflows.

### FIELD

The present invention relates to subsurface rock formation stimulation and, more particularly, to methods and systems for enhancing mineral dissolution and fracture network permeability in subsurface rock formations through the application of surface-based electromagnetic fields coupled to electromagnetically responsive granular media disposed within fracture networks. The invention finds application in hydrocarbon-bearing reservoirs, geothermal energy systems, and other subsurface rock formations in which improved permeability or fracture conductivity is desired.

### BACKGROUND

Subsurface formations of commercial interest, including hydrocarbon-bearing reservoirs and geothermal systems, commonly exhibit low permeability or limited fracture connectivity that restricts fluid flow and reduces economic productivity. Various stimulation techniques have been developed to enhance permeability in such formations, including hydraulic fracturing, matrix acidizing, and thermal methods. While these approaches have achieved widespread adoption, each carries significant technical and operational limitations that the present invention addresses.

### Hydraulic Fracturing and Conventional Proppants

Hydraulic fracturing involves injecting pressurized fluid into a subsurface formation to propagate fractures, followed by introduction of granular proppant materials, typically sand, ceramic beads, or resin-coated particles, into the fractures to maintain aperture under in situ stress after pressure is released. Conventional proppants are chemically passive: they are designed to bear compressive load and preserve fracture aperture, but do not actively contribute to permeability enhancement through chemical or electrochemical mechanisms. As a result, the extent and uniformity of stimulation is limited by the physical placement of proppant and the initial fracture geometry, with no capacity for post-placement activation or adjustment.

### Chemical Acidizing And Reactive Fluid Treatments

Matrix acidizing and acid fracturing rely on injecting reactive chemical solutions, typically hydrochloric acid or hydrofluoric acid blends, into the formation to dissolve minerals and enlarge pore throats or fracture surfaces. These approaches suffer from several limitations. First, chemical penetration into the formation is governed by bulk fluid flow and diffusion, leading to uneven dissolution and preferential channeling along high-permeability pathways. Second, acid treatments are irreversible and non-controllable once injected: the extent of dissolution cannot be modulated without additional chemical injection. Third, the use of corrosive and potentially hazardous chemicals introduces operational, safety, and environmental risks, including corrosion of wellbore infrastructure, handling hazards, and concerns regarding subsurface fluid and aquifer contamination.

### Thermal Methods

Thermal stimulation methods, including steam injection and resistive downhole heating, rely on bulk temperature elevation to alter formation properties. These approaches require substantial energy input and create spatially non-uniform heating profiles that may affect formation structure or alter local fluid properties in undesired ways.

### Limitations of the Prior Art

No existing approach combines: (1) electromagnetically responsive granular media capable of interacting with subsurface fields; (2) surface-based electromagnetic induction capable of coupling to kilometer-depth fracture networks without downhole power delivery; and (3) electrochemical mineral dissolution driven by induced currents rather than chemical concentration or temperature. Existing subsurface stimulation methods are passive, irreversible, chemically intensive, or limited in depth and spatial control. There exists a need in the art for a method and system that enables active, controllable, and spatially distributed mineral dissolution in subsurface fracture networks without requiring downhole electronics, embedded electrodes, or the injection of corrosive chemical additives.

### SUMMARY

The present invention is a method and system for mineral dissolution and permeability enhancement in subsurface rock formations employing surface-based electromagnetic fields interacting with electromagnetically responsive granular media disposed within fracture networks. The invention exploits the electrical conductivity of fracture fluids as distributed current pathways, enabling electromagnetic fields applied at the surface to induce localized electrochemical redox reactions at mineral surfaces within fracture networks extending to kilometer-scale depths, without the need for downhole power delivery, embedded electronics, or chemically reactive additives.

In one aspect, the invention provides a method comprising: distribution of electromagnetically responsive granular particles into subsurface channels or fractures; application of a surface-based electromagnetic field of selected type, frequency and amplitude and the coupling of this electromagnetic field to conductive fluids in the rock formation to induce electromagnetic currents within the fracture network; use of the interaction between induced currents and the granular particles to modify local electromagnetic field strength and distribution in the rock formation; promotion of electrochemical redox reactions at mineral surfaces to enhance material dissolution; and thereby increase fracture connectivity and permeability of the subsurface formation.

In another aspect, the invention provides a system comprising a surface-based electromagnetic field generation apparatus, a subsurface fracture network containing conductive fluids, and a plurality of electromagnetically responsive granular particles disposed within the fracture network, wherein electromagnetic coupling between the surface apparatus and the fracture fluids induces currents that interact with the granular particles to produce localized electrochemical mineral dissolution in adjacent material.

The granular particles may comprise, without limitation, magnetic materials such as magnetite (Fe₃O₄), semiconducting or dielectric materials, ferroelectric, pyroelectric and piezoelectric materials, conductive metal or metal-oxide composites, or combinations thereof. The particles may be sized and configured to maintain hydraulic conductivity within the fractures. The electromagnetic field is controllable via type, frequency, amplitude, and waveform, enabling activation, modulation, or cessation of stimulation without additional chemical injection.

The invention is compatible with existing hydraulic fracturing and hydraulic shearing workflows and may be activated during or after well completion. The method provides distributed, non-thermal stimulation across interconnected fracture networks, distinct from point-source electrochemical systems and bulk thermal methods.

Key advantages of the present invention include: controllable stimulation without chemical re-treatment; reduced reliance on corrosive or hazardous chemical additives; effective field coupling to kilometer-scale depths without downhole power delivery; applicability to hydrocarbon-bearing formations, geothermal reservoirs, and other subsurface mineralized systems; and compatibility with post-completion well operations.

### BRIEF DESCRIPTION OF THE DRAWINGS

The accompanying drawings illustrate embodiments of the present disclosure and are incorporated herein. The embodiments may be better understood by reference to these drawings in combination with the detailed description that follows this section.

FIG. 1 is a cross-sectional schematic of a subsurface formation showing a wellbore, fracture network, and distribution of electromagnetically responsive granular particles within fractures, plus surface-based electromagnetic source.

FIG. 2 is a set of four plots showing simulated depth profiles illustrating electromagnetic field concentration and electric current at depth.

FIG. 3 is a set of six plots illustrating simulated local electromagnetic field and redox gradients at individual particles adjacent to dissolving mineral surfaces.

FIG. 4 is a set of four plots showing simulated time-evolution of mineral dissolution rate and permeability enhancement under electromagnetic stimulation compared to unstimulated controls.

FIG. 5 is a set of six star plots comparing simulated electromagnetic coupling, and thermal, mechanical, and chemical stability of representative particles in different conditions.

### DETAILED DESCRIPTION

The following detailed description sets forth specific embodiments of the invention with reference to the drawings. The embodiments described herein are illustrative and non-limiting. The present disclosure may be practiced in various forms without departing from the spirit and scope of the appended claims.

### Overview of the Inventive System and Method

The present disclosure provides a method and corresponding system for stimulating mineral dissolution and enhancing permeability in subsurface rock fracture networks by applying surface-based electromagnetic fields that inductively couple to electrically conductive fluids, inducing localized electrochemical reactions at mineral surfaces in the presence of electromagnetically responsive granular media. The method exploits three components not typically combined in subsurface stimulation: (1) the intrinsic electrical conductivity of subsurface fracture fluids as distributed induction pathways; (2) purpose-selected granular particles with electromagnetically responsive properties; and (3) surface-based electromagnetic field sources capable of coupling to depth without downhole electronics. While not bound by theory, such coupling may give rise to localized electrochemical gradients. In some embodiments, system performance may be monitored via changes in electrical, chemical, or flow properties of the formation, enabling adjustment of electromagnetic parameters over time.

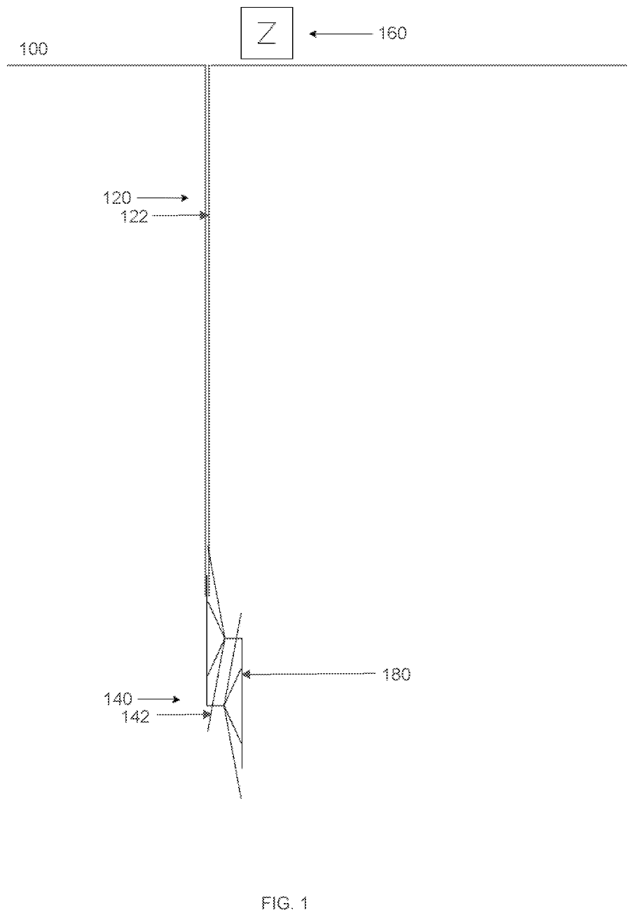

FIG. 1 illustrates a surface region (100) overlying a subsurface formation including a wellbore (120) containing conductive fluids (122) and a fracture network, reservoir, or mineral deposit (140) containing conductive fluids (142). One or more electromagnetic sources (160) are positioned at or near the surface and are configured to transfer electromagnetic energy to the subsurface formation via induction or current flow and, in some embodiments, to monitor changes in the electromagnetic response. Electromagnetically responsive particles (180) disposed within the fracture network, reservoir, or mineral deposit are capable of coupling with the electromagnetic phenomena, thereby modifying the local electromagnetic environment and potentially promoting mineral dissolution and permeability enhancement.

The method provides an electrochemically-driven stimulation mechanism that is controllable and operable, and in some embodiments, operates without requiring additional chemical re-injection. The system integrates directly with existing hydraulic fracturing and hydraulic shearing workflows, enabling stimulation during proppant or other particle placement or post-completion activation. In various embodiments, the relative contributions of electromagnetic induction, electrochemical reactions, and fluid transport may vary depending on formation properties, particle composition, and operating conditions.

### Subsurface Formation and Fracture Network

The present disclosure is applicable to subsurface formations at depths ranging from near-surface to multiple kilometers, including, for example, hydrocarbon-bearing formations such as tight sandstones, carbonates, and shale reservoirs; geothermal reservoirs in which enhanced fluid circulation is sought; and other mineralized subsurface systems in which selective mineral dissolution may improve permeability or fluid flow characteristics.

Fracture networks within the formation, whether natural or induced by hydraulic fracturing or hydraulic shearing, or a combination thereof, provide the physical pathways through which granular particles are introduced and within which electromagnetically induced currents are generated or channeled. The presence of electrically conductive fluids (including brines, formation waters, or injected conductive fracture fluids) within the well and fracture network is commonly satisfied in commercially developed subsurface formations in some embodiments. Fluid conductivity values in the range of 0.01 to 10 S/m, for example, are representative of subsurface brines encountered in such formations, though the invention is not limited to any specific conductivity range. In some embodiments, conductivity may be enhanced through the introduction of conductive additives or fluids.

### Electromagnetically Responsive Granular Particles

In some implementations, the use of granular particles specifically selected or engineered for electromagnetic responsiveness is distinct from conventional proppants that primarily provide mechanical support. The granular particles introduced into the fracture network are characterized by at least one of the following properties: (a) magnetic susceptibility or magnetic behavior including but not limited to ferromagnetism, ferrimagnetism, paramagnetism, antiferromagnetism, antiferrimagnetism, diamagnetism; (b) semiconductor or dielectric properties; (c) ferroelectricity; (d) pyroelectricity; (e) piezoelectricity; (f) electrical conductivity sufficient to modify local current density distributions within fracture fluids; or (g) capacity to participate in redox reactions at grain surfaces when subjected to induced electrochemical potentials. Examples of suitable materials include, for illustrative purposes only, magnetite (magnetic), silicon carbide (semiconductive and piezoelectric), barium titanate (ferroelectric), schorl (pyroelectric), quartz (piezoelectric), and metallic grains (conductive and redox-active).

The granular particles are dimensioned and configured to preserve hydraulic conductivity within the fractures in which they are placed. Particle sizes in the range of 50 to 2000 micrometers, for example, are contemplated in certain embodiments, e.g. hydrocarbon-bearing formations, and smaller in others, e.g. enhanced geothermal systems, with size distribution selected to reduce the likelihood pore plugging while maintaining adequate packing density for electromagnetic interaction. The particles are not limited to any single size or composition. Composite particles combining multiple functional properties are also within the scope of the invention.

In embodiments where the particles are introduced during a hydraulic fracturing operation, they may be premixed with conventional fracturing fluid or pumped in a dedicated stage following conventional proppant placement. Following placement of conventional proppants, particles may be introduced through coiled tubing, bullhead injection, or other established well intervention techniques.

### Surface-Based Electromagnetic Field Generation

The electromagnetic field source of the present disclosure is positioned at or near the surface, above or proximate to the subsurface formation of interest, and in some embodiments can be operational with no embedded electronics or borehole electrodes. This may provide an operational distinction from systems that typically utilize downhole electrodes and aim for near-surface effects, e.g. electrokinetic remediation systems.

In various embodiments, the surface-based electromagnetic field generation apparatus comprises one or more of: dipole transmitter antennas, including horizontal or vertical dipole configurations; inductive coil arrays positioned at the surface configured to generate oscillatory magnetic fields that propagate into the subsurface formation through magnetic induction; surface current injection systems, which may include surface electrodes in certain embodiments, configured to generate oscillatory subsurface currents; or dedicated magnetic field generation sources, including surface-deployed Helmholtz coil configurations, toroidal coil arrays, or pulsed magnetic dipole systems, configured to produce controlled low-frequency magnetic flux density within the subsurface formation. The apparatus is configured to generate and, in some embodiments, monitor and adjust oscillatory electromagnetic fields, including configurations that are electric-field dominant, magnetic-field dominant, or combinations thereof, with selectable frequency, for example, 0.001 Hz to 10,000 Hz, encompassing DC, ELF, and VLF bands, selectable amplitude, and controllable waveform, including sinusoidal, pulsed, or multi-frequency waveforms. In magnetic-field-dominant embodiments, the oscillatory magnetic flux induces eddy currents within conductive fracture fluids and electromagnetically responsive granular media through Faraday induction, thereby contributing to electrochemical activation effects.

Frequency selection governs the skin depth, spatial distribution, and relative electric-to-magnetic field coupling efficiency of induced currents within the formation. Lower frequencies, i.e. in the DC to ELF range, achieve greater penetration depth with reduced attenuation for both electric and magnetic field components, while higher frequencies, i.e. VLF range or higher, may offer enhanced inductive coupling to localized conductive structures such as fluid-filled fracture networks. Magnetic field penetration at low frequencies is governed primarily by the magnetic permeability and electrical conductivity of the formation, and may be less susceptible to attenuation by resistive overburden layers than electric field-dominant configurations, providing a complementary depth-penetration pathway in formations with heterogeneous electrical properties. In certain embodiments suitable for deep reservoir applications, for example at depths of 1-8 km, operating frequencies in the range of approximately 0.01 Hz to 100 Hz are contemplated for both electric and magnetic field generation modes, though the invention is not limited to this range. In certain embodiments, combined electric and magnetic field excitation is applied simultaneously or in alternating sequences to exploit the distinct coupling pathways of each field component across varying formation conditions.

### Electromagnetic Coupling Mechanism and Field Propagation

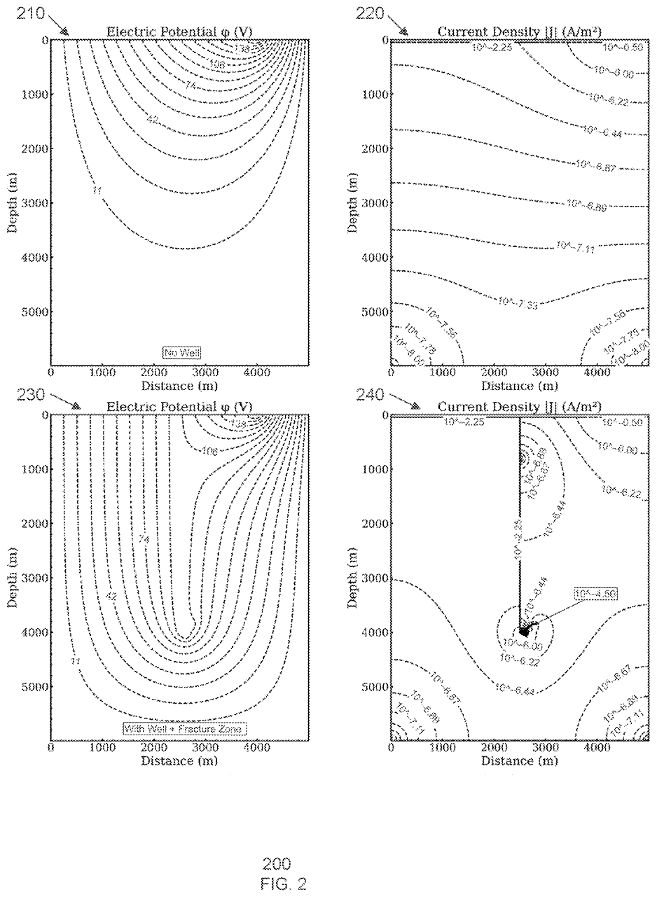

Electromagnetic phenomena at a local surface interact with subsurface rock and other features and may concentrate in conductive channels under certain conditions. FIG. 2 depicts four plots of a numerical depth-penetration simulation (200) with an applied surface-based electromagnetic field (source at x=4000 m, overburden conductivity=1.0 S/m, rock conductivity=1×10⁻⁵ S/m). Plots in the top row show electric potential (210) and electric current density (220) in a scenario with no well nor fracture zone. Plots in the bottom row show electric potential (230) and electric current density (240) in a scenario with a well and fracture zone in which the well fluid conductivity is 4.0 S/m and the fracture zone has typical anisotropic conductivity (parallel=0.2 S/m; perpendicular=0.002 S/m). In the depicted simulation scenario with well and fracture zone shown in (230) and (240), current density (240) was increased by approximately three orders of magnitude compared to the surrounding rock. Penetration of the electric potential and current density may preferentially follow well and fracture zone features to depth, as conductive fluids act as distributed current pathways. Without being bound by theory, this observed distributed pathway effect, sometimes referred to as current channeling, can result in preferential current concentration within fluid-filled fracture zones relative to the surrounding rock matrix.

Simple illustrative numerical electromagnetic simulations were conducted investigating whether surface-applied fields in the ULF (quasi-DC) frequency range can produce non-trivial current densities at depths of several kilometers within fluid-saturated fracture networks. These were based on quasi-DC current flow with Ohm's law J=sigma E and current conservation div J=0, with the governing equation div (sigma grad phi)=−I ×delta (x−x_source), where phi=electric potential, E=−grad phi=electric field, J=sigma E=current density and sigma=conductivity tensor. This corresponds to the DC limit (omega->0) of Maxwell's equations, generally applicable when sigma is much greater than omega epsilon, i.e. conduction currents dominate displacement currents. Dirichlet boundary conditions (phi=0) were imposed on model sides and bottom to approximate a semi-infinite half-space while suppressing artificial reflections from model edges. Thirty-two scenarios were run with four different well geometries (including a control scenario with no well), two surface electromagnetic field source locations, two rock conductivities, and the presence or absence of a conducting rock overburden. Results showed current enhancement in the well and fracture zones of one to three orders of magnitude compared to the surrounding rock.

### Grain-Scale Electromagnetic Interaction and Electrochemical Activation

Within a fracture network, interaction between the electromagnetically responsive granular particles and local electromagnetic phenomena may produce localized modifications to electric field distribution and current density at the grain-fluid and grain-rock interfaces. Without being bound by theory, the nature of these interactions may depend on the electromagnetic properties of the selected particles. For example, ferroelectric particles may develop surface charge in response to applied electric fields, or in some environments, to natural fields, or a combination of both, potentially generating local potential differences that may drive ion migration and surface reactions at adjacent mineral interfaces. Pyroelectric particles may develop charge in response to changes in temperature. Piezoelectric particles may develop charge in response to stress and strain. Conductive particles may concentrate current density at their surfaces and edges, potentially producing locally elevated electric fields and electrochemical potential gradients at grain surfaces adjacent to rock and constituent minerals. Magnetic particles may interact with local oscillatory magnetic fields associated with applied electromagnetic sources or, in some environments, to natural variations in the local geomagnetic field, or both, potentially contributing to current concentration and magnetically-coupled polarization effects. Other magnetic properties may contribute to current concentration and magnetically-coupled polarization effects. Other material properties, e.g. semiconductive behavior, may concentrate current. In some embodiments, the effect at grain scale may be to generate local electrochemical driving forces, including modifications to local electrode potential (Eh) and proton activity (pH), that may promote dissolution of adjacent minerals through redox-mediated reaction pathways.

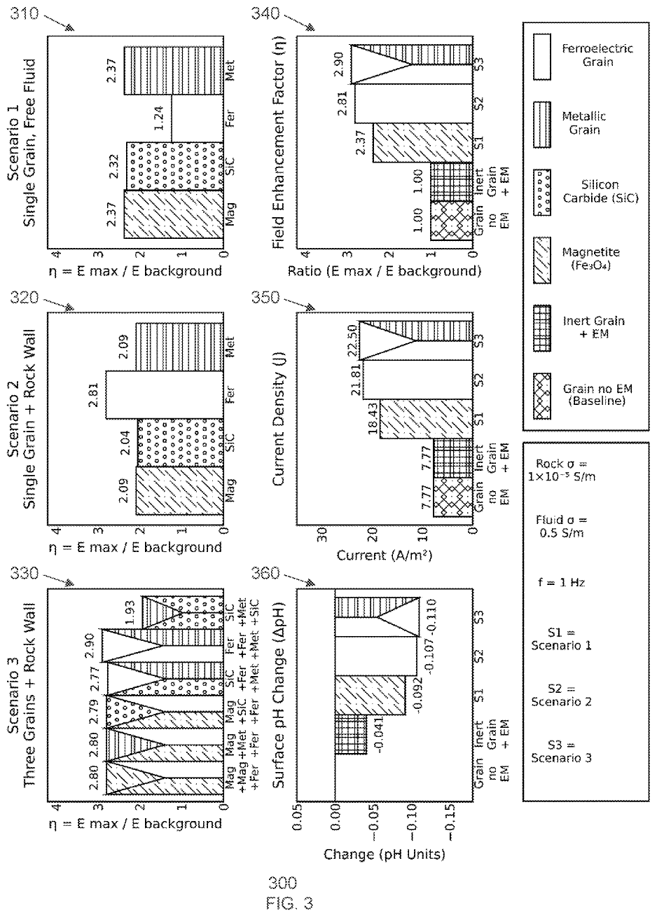

FIG. 3 depicts example simulations of grain-fluid and grain-rock interaction (300) showing potential electric field enhancement with a single-grain free-fluid scenario (310), a single-grain rock-wall scenario (320) and a three-grain rock-wall scenario (330). Also depicted are a summary plot with the top representative field-enhancing grains of each illustrative scenario (340), as well as plots of current density (350), and of grain-surface pH change (360) for example grains under representative conditions of frequency=1 Hz, rock conductivity=1×10⁻⁵ S/m and fluid conductivity of 0.5 S/m. In illustrative scenarios, increases on the order of approximately twofold were observed relative to control conditions.

Simple illustrative numerical electromagnetic simulations were conducted with the quasi-static complex conductivity equation, div (sigma* grad phi)=0, where sigma*=sigma_real+i omega epsilon_0 epsilon_r is the complex conductivity. In the illustrative simulations 300, applied Dirichlet boundary conditions were: phi=1 at the source face, phi=0 at the sink face, plus natural (Neumann) boundary conditions on all lateral faces, namely no lateral current flux. Potential field enhancement was computed from E=-grad phi. Example grains used for these simulations comprised magnetite, silicon carbide, a generic metallic grain, and a generic ferroelectric grain, plus an electromagnetically inert grain for control. Enhancement of electric field and current density, along with reduction of pH, are seen in all three illustrative scenarios. Local changes to grain-scale electromagnetic phenomena may support increased dissolution of adjacent minerals through redox-mediated reaction pathways.

### Electrochemical Mineral Dissolution Mechanism

Without being bound by theory, an electrochemical dissolution mechanism potentially active in the present disclosure may include anodic and cathodic half-reactions analogous in some respect to those occurring in electrochemical corrosion cells, but may be influenced or controlled via external electromagnetic parameters rather than fixed chemical composition. Local redox cycling may facilitate hydrolysis or other bond-breaking reactions in constituent minerals. Dissolution may be concentrated at mineral surfaces adjacent to electromagnetically active grain surfaces, potentially creating localized porosity enhancement. Dissolution rate and spatial distribution may be altered by varying electromagnetic field parameters (location, type, frequency, amplitude, waveform, duty cycle). When an electromagnetic field is removed, electrochemically driven dissolution may slow or cease in certain embodiments without requiring chemical neutralization or washout procedures.

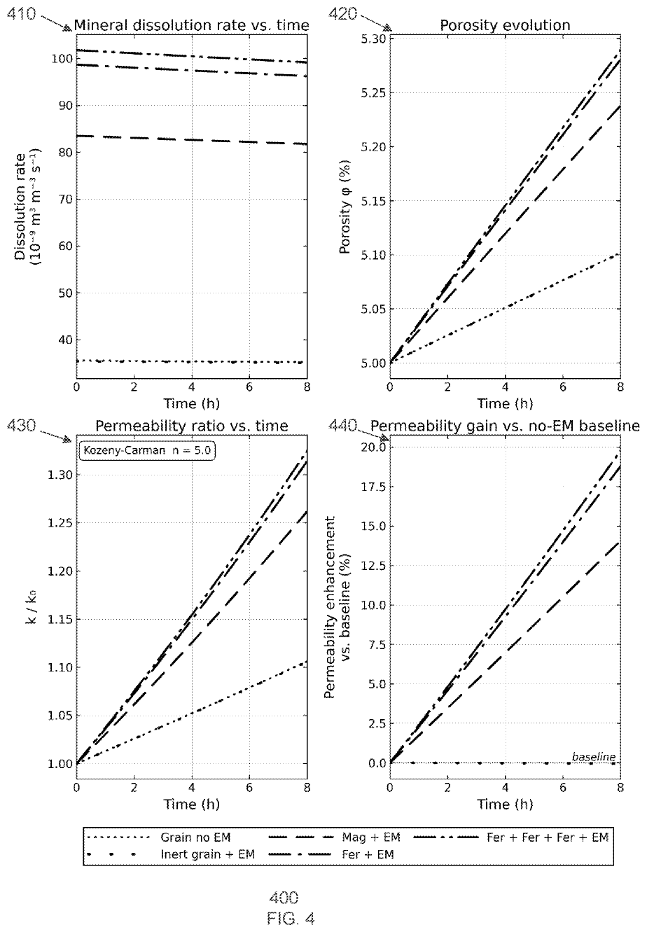

FIG. 4 depicts results from an illustrative 8-hour simulation of grain-fluid and grain-rock interaction (400) including mineral dissolution rate (410), porosity evolution (420), permeability enhancement (430), and permeability enhancement normalized to baseline without applied electromagnetic field (440). In this one illustrative scenario, permeability increased by approximately 10-20% relative to baseline after 8 hours, although the present disclosure is not limited to such values. Porosity evolution was calculated from mineral volume reduction in this sample simulation.

### Integration with Hydraulic Fracturing and Hydraulic Shearing Operations

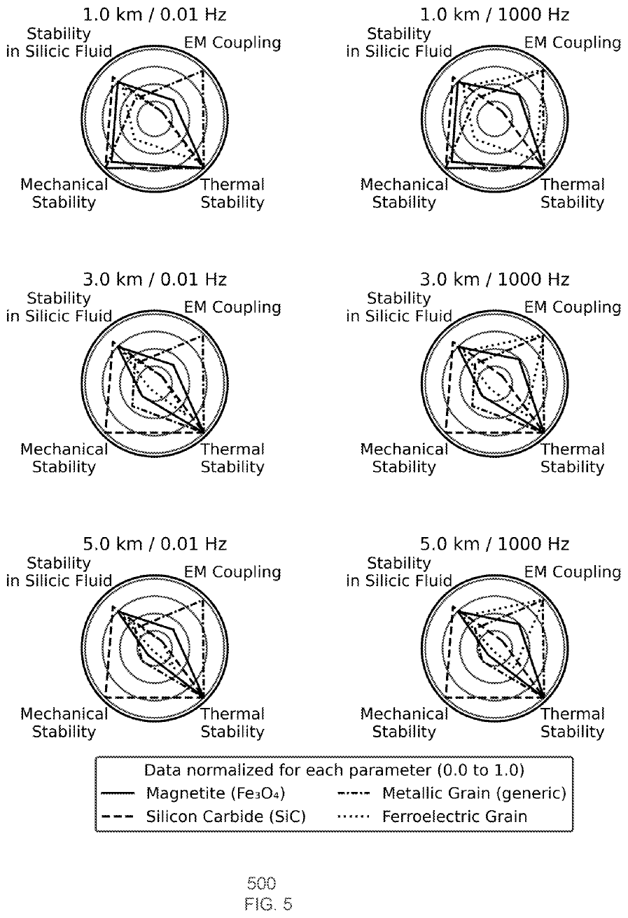

The present disclosure is compatible with existing hydraulic fracturing and hydraulic shearing workflows. In one embodiment, electromagnetically responsive granular particles are introduced into a fracture network as a pre-treatment, as part of, or immediately following, a conventional hydraulic fracturing treatment, either premixed with proppant-laden fracturing fluid or pumped in a dedicated stage. FIG. 5 depicts illustrative grain-type simulations (500) showing variations in electromagnetic coupling, and thermal, mechanical, and chemical stability in silica-rich fluid for different grain types to depict grain selection parameters that may be important according to operating conditions in some embodiments. In this illustrative simulation, electromagnetic dissipation was modeled analytically using electromagnetic attenuation and dielectric response parameters.

A surface-based electromagnetic field generation apparatus is deployed at or near the surface before, during or after hydraulic fracturing or hydraulic shearing operations. In a post-completion embodiment, the electromagnetic field generation apparatus is deployed after well completion and initial production, potentially enabling stimulation of existing fracture networks without refracturing or re-drilling. This capability may enable iterative or staged activation in response to declining productivity or evolving subsurface conditions. In various embodiments, the electromagnetic stimulation may be applied intermittently (pulsed activation) or continuously, and may be varied in location, type, frequency, amplitude, and waveform over time to influence or improve dissolution distribution across a fracture network.

### Application to Geothermal Reservoirs

The invention is applicable to a wide range of geothermal reservoirs in which enhanced permeability or improved fracture connectivity is sought for heat extraction purposes. In some geothermal embodiments, high-temperature brine fluids present in geothermal reservoirs provide sufficient ionic conductivity for electromagnetic coupling, and the dissolution of silica-bearing minerals or carbonates deposited as scale within the geothermal reservoir represents one application of interest. The methods and system described herein are applicable to geothermal wells using established injection and completion techniques. In other geothermal embodiments, the invention is particularly suited to the development and maintenance stages of enhanced geothermal systems, and may provide advantages relative to traditional hydraulic shearing in fracture and reservoir development and maintenance. The methods and system described herein are also applicable to geothermal wells using emerging or non-conventional pre-treatment, injection and completion techniques.

### Application to Hydrocarbon Reservoirs

The present disclosure is applicable to hydrocarbon-bearing formations in which enhanced permeability, improved fracture conductivity, or mitigation of formation damage is desired. Such formations may include conventional and unconventional reservoirs, including tight sandstones, carbonate reservoirs, and shale formations, in which fluid flow is constrained by low matrix permeability, mineral scaling, or fines migration.

In some embodiments, electromagnetically induced electrochemical activity may facilitate dissolution or alteration of mineral phases that contribute to pore blockage or reduced fracture conductivity. These may include, for example, carbonate minerals, silica-based deposits, sulfate scales, or other precipitated or authigenic phases present within pore spaces or fracture networks. Localized electrochemical gradients generated in the presence of electromagnetically responsive granular particles may promote dissolution at mineral-fluid interfaces without requiring bulk chemical modification of the injected fluid.

The methods described herein may be applied during multiple stages of reservoir development and production, including initial completion, refracturing, and post-completion production enhancement operations. In certain embodiments, electromagnetic stimulation may be applied intermittently or continuously to influence the spatial distribution of dissolution and permeability modification within the reservoir. The disclosed approach may be used in conjunction with conventional hydraulic fracturing treatments, proppant placement strategies, or well intervention techniques, and may enable targeted modification of flow pathways within existing fracture networks. In some embodiments, the methods may also contribute to reduction of near-wellbore damage, modification of fracture conductivity over time, or mitigation of scale accumulation during production, although the present disclosure is not limited to any particular mechanism or outcome.

### Application to Mineral Extraction Systems

In certain embodiments, the present disclosure may be applied to mineralized subsurface systems in which in situ modification of permeability or enhancement of mineral dissolution is desired. Such systems may include ore-bearing formations, fractured rock masses, or porous media in which extraction efficiency is influenced by fluid access to mineral surfaces. Electromagnetically induced electrochemical processes, particularly when coupled with electromagnetically responsive granular particles, may facilitate localized dissolution, alteration, or mobilization of target mineral phases within fracture networks or pore structures.

In some embodiments, these processes may enhance access of leaching fluids to mineral surfaces, increase effective reactive surface area, or promote release of ions or dissolved species from the mineral matrix. The disclosed methods may be integrated with in situ recovery (ISR), solution mining, or other subsurface extraction techniques in which fluid injection and recovery are used to mobilize valuable constituents. In certain embodiments, electromagnetic stimulation may be applied before, during, or after fluid injection to influence permeability distribution, reaction kinetics, or transport pathways within the formation. In some implementations, the methods may enable more spatially controlled or selective dissolution relative to bulk chemical treatments, potentially reducing reagent consumption or improving recovery efficiency. However, the present disclosure is not limited to any particular extraction process, mineral type, or recovery mechanism.

1. A method of increasing mineral dissolution and permeability in a subsurface formation, comprising:
(a) introducing a plurality of electromagnetically responsive granular particles into one or more fractures or other fluid-conducting pathways within the subsurface formation, the fractures or pathways containing a conductive fluid, wherein the granular particles are sized and configured to maintain fluid flow through the fractures or pathways without substantial occlusion;
(b) applying, from a location at or near the surface, an electromagnetic field having a selected waveform, frequency and amplitude;
(c) inductively coupling the applied electromagnetic energy to the conductive fluid within the fractures or pathways to induce electric currents within a fracture network or pathways;
(d) causing interaction between the induced electric current and the granular particles to modify local electric field gradients and current density distributions within the fractures or pathways;
(e) thereby inducing electrochemical redox reactions at mineral surfaces within the fractures or pathways; and
(f) thereby increasing permeability or fluid-path connectivity of the subsurface formation.

2. A system for enhancing electrochemical mineral reactions in a subsurface formation, comprising:
(a) a surface-based generation apparatus configured to generate an electromagnetic field having a selectable waveform, frequency and amplitude;
(b) a subsurface formation including a fracture network or fluid pathways containing electrically conductive fluids;
(c) a plurality of electromagnetically responsive granular particles disposed within at least a portion of the fracture network or fluid pathways, and sized and configured to avoid substantial occlusion of fluid pathways;
(d) wherein the electromagnetic field generation apparatus is configured to couple, including inductively, the electromagnetic field to the conductive fluids so as to induce electric currents within the fracture network or pathways; and
(e) wherein interaction between the electric currents and the granular particles produces localized electric field gradients and current density concentrations at or near mineral surfaces sufficient to promote electrochemical mineral dissolution.

3. The method of claim 1, wherein the granular particles comprise conductive metal or metal-oxide composites configured to participate in electrochemical redox reactions.

4. The method of claim 1, wherein the granular particles comprise magnetic or magnetically responsive materials.

5. The method of claim 1, wherein the granular particles comprise ferroelectric materials including ferroelectric ceramic materials.

6. The method of claim 1, wherein the granular particles comprise piezoelectric, pyroelectric, or semiconducting or dielectric materials configured to generate or amplify electrical charge under applied electromagnetic fields or environmental changes.

7. The method of claim 1, wherein the granular particles comprise composite materials having a combination of electromagnetic properties.

8. The method of claim 1, wherein the granular particles have a characteristic size between approximately 0.0 1μm and 2000 μm.

9. The method of claim 1, wherein the electromagnetic field comprises a magnetic-field-dominant oscillatory field.

10. The method of claim 1, wherein the induction in the conductive fluid produces eddy currents at depth that interact with electromagnetically responsive particles.

11. The method of claim 1, wherein the electromagnetic field has a frequency selected from a range of approximately 0.001 Hz to 10,000 Hz.

12. The method of claim 1, wherein the frequency of the electromagnetic field is selected based on skin depth or formation conductivity.

13. The method of claim 1, wherein the electromagnetic field is applied intermittently in a pulsed activation mode.

14. The method of claim 1, wherein the electromagnetic field is supplemented by a surface-applied electric current source or at least partially coupled via conductive current injection into the conductive fluid.

15. The method of claim 1, wherein the electromagnetic field is applied without use of downhole electrodes or electronics.

16. The method of claim 1, wherein the conductive fluid comprises a brine having an electrical conductivity of at least approximately 0.01 S/m.

17. The method of claim 1, wherein introducing the granular particles comprises introducing the particles during a hydraulic fracturing or hydraulic shearing operation.

18. The method of claim 1, wherein the electromagnetic field is applied during a hydraulic fracturing or hydraulic shearing operation.

19. The method of claim 1, wherein the electromagnetic field is applied after completion of a well in the absence of additional drilling or fracturing operations.

20. The method of claim 1, wherein the subsurface formation comprises a hydrocarbon-bearing reservoir.

21. The method of claim 1, wherein the subsurface formation comprises a geothermal reservoir.

22. The method of claim 1, wherein the subsurface formation comprises an economic mineral deposit.

23. The method of claim 1, further comprising monitoring an electrical, magnetic or electromagnetic response of the subsurface formation during application of the electromagnetic field.

24. The method of claim 23, further comprising adjusting at least one parameter of the electromagnetic field based on the monitored response in a closed-loop control mode.

25. The system of claim 2, wherein the granular particles comprise at least one of: metallic composites, magnetic materials, ferroelectric materials, or piezoelectric, pyroelectric, or semiconducting or dielectric materials.

26. The system of claim 2, wherein the electromagnetic field generation apparatus comprises surface-deployed coils, grounded dipole antennas, or inductive arrays positioned at or near a surface location relative to a wellbore.

27. The system of claim 2, wherein the electromagnetic field generation apparatus is configured to operate in a frequency range of approximately 0.001 Hz to 10,000 Hz.

28. The system of claim 2, further comprising a control unit configured to modulate the electromagnetic field based on a measured electrical, magnetic or electromagnetic response of the subsurface formation.
